(19) United States
(12) Patent Application Publication
(10) Pub. No.: US 2026/0042108 A1
(43) Pub. Date: Feb. 12, 2026

(54) SPRING-LOADED SPRAYING DEVICE

(71) Applicant: Patrick Austin, Tecumseh (CA)

(72) Inventor: Patrick Austin, Tecumseh (CA)

(21) Appl. No.: 19/104,479

(22) PCT Filed: Jun. 23, 2022
(86) PCT No.: PCT/CA2022/051010

§ 371 Date: Feb. 18, 2025

(51) Int. Cl. B05B 9/08; B05B 7/08

(52) U.S. Cl. CPC B05B 9/0838; B05B 7/08

(57) ABSTRACT

The present specification relates generally to spraying devices and more specifically to a spring-loaded portable spraying device for dispersing liquids without electricity or gas propellants and a related method. The spring-loaded spraying device comprises at least one canister assembly, wherein each canister assembly comprises a canister; a rod partially contained within the canister; at least one spring, wherein the at least one spring is coiled around the rod; and a spring-locking mechanism; a canister recipient, for receiving the at least one canister assembly; at least one fluid channel in communication with the at least one canister and extending through the canister recipient; a valve within the at least one fluid channel; a trigger assembly functionally connected with the valve; and a handle connected to the canister recipient.

### FIELD OF THE INVENTION

The present specification relates generally to spraying devices and more specifically to a spring-loaded portable spraying device for dispersing liquids without electricity or gas propellants.

### BACKGROUND OF THE INVENTION

Spraying has long been a preferred method of dispersing a variety of liquids, particularly coatings, as a result of its relative ease, accessibility to anyone from professional to amateur, and ability to disperse a given liquid relatively evenly and over a large area.

Existing spraying devices depend upon one or more of: propellants, electricity, pump systems, and compressors to power the dispersion of a given liquid. As a result, these devices tend to be large, heavy, difficult to transport, dangerous and/or dependent on an electrical hookup. Further, certain liquids cannot be pressurized or hand pumped and are incompatible with many of today's spraying devices. The pressurization or hand-pumping of these liquids may cause them to, for example, foam, bubble or harden. As a result, the use of small, portable spraying devices may not be feasible and larger, electric equipment may be required to spray these liquids. This limitation is particularly common among environmentally friendly products. As companies shift more and more toward such products, this is likely to become a significant obstacle to their implementation and market success.

While aerosol sprays are a common choice as they are portable and do not require electricity, these sprays too have their disadvantages, as they generally house a relatively small amount of product. Relying on aerosol sprays as a method of dispersion can therefore mean purchasing, emptying, and disposing of multiple cans to complete a single project. Further, due to the gas propellants housed within these sprays, aerosol sprays are explosive and may become dangerous if exposed to heat.

Existing spraying devices also do not permit users to spray two or more liquids simultaneously with a single device in a manner where the two or more liquids cross paths and interact only after exiting the device. Simultaneous spraying of two more liquids with overlapping trajectories is particularly desirable where the two or more liquids include a catalyst and a reactant.

Accordingly, there remains a need for improvements in the art.

### SUMMARY OF THE INVENTION

In an embodiment of the present invention, there is provided a spring-loaded spraying device comprising: at least one canister assembly, wherein each canister assembly comprises a canister; a rod partially contained within the canister; at least one spring, wherein the at least one spring is coiled around the rod; and a spring-locking mechanism; a canister recipient, for receiving the at least one canister assembly; at least one fluid channel in communication with the at least one canister and extending through the canister recipient; a valve within the at least one fluid channel; a trigger assembly functionally connected with the valve; and a handle connected to the canister recipient.

According to another embodiment, there is provided a method of spraying a liquid, comprising: retracting a rod within a canister; locking the rod in a retracted position; loading the liquid into the canister; and unlocking the rod.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a cross-sectional view of a spring-loaded spraying device according to an embodiment;

FIG. 2 is a bottom-left perspective view of a spring-loaded spraying device according to an embodiment;

FIG. 3 is a front-left perspective view of a spring-loaded spraying device according to an embodiment;

FIG. 4 is a rear view of a spring-loaded spraying device according to an embodiment;

FIG. 5 is a side perspective view of a canister assembly according to an embodiment;

FIG. 6 is a cross-sectional view of a canister assembly according to an embodiment; and

FIG. 7 is a side view of a flexible tube according to an embodiment.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order more clearly to depict certain features of the invention.

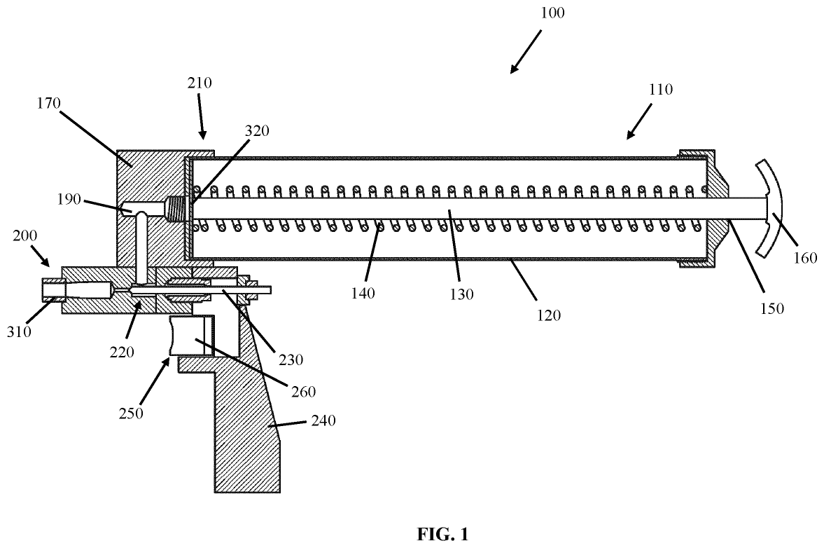

According to an embodiment, as shown in FIG. 1, a spring-loaded spraying device 100 is provided to enable the spray dispersion of a liquid without propellants, electricity, pump systems, or compressors, and to enable the simultaneous dispersion of two separate liquids with overlapping trajectories with a single device. Accordingly, spring-loaded spraying device 100 may facilitate the spray dispersion of products which cannot be pressurized or hand pumped. Spring-loaded spraying device 100 may also reduce waste and safety risk associated with reliance on single-use aerosol sprays. Further, spring-loaded spraying device 100 may facilitate the independent and simultaneous dispersion of liquid catalysts and reactants. Spring-loaded spraying device 100 may reduce the cost and logistical challenges associated with spray dispersion and particularly with the rental, purchase, storage, maintenance, transportation, and powering of existing spraying devices. Consequently, spring-loaded spraying device 100 may make spray dispersion more accessible.

Spring-loaded spraying device 100 includes at least one canister assembly 110, wherein at least one canister assembly 110 comprises a canister 120; a rod 130 partially contained within canister 120; at least one spring 140, wherein at least one spring 140 is coiled around rod 130; and a spring-locking mechanism, not shown.

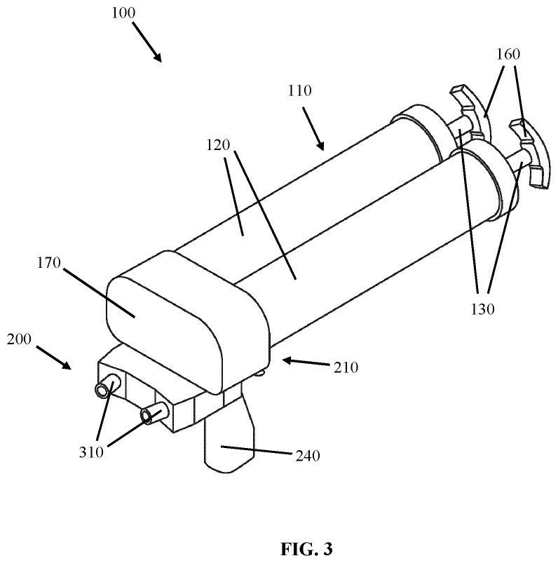

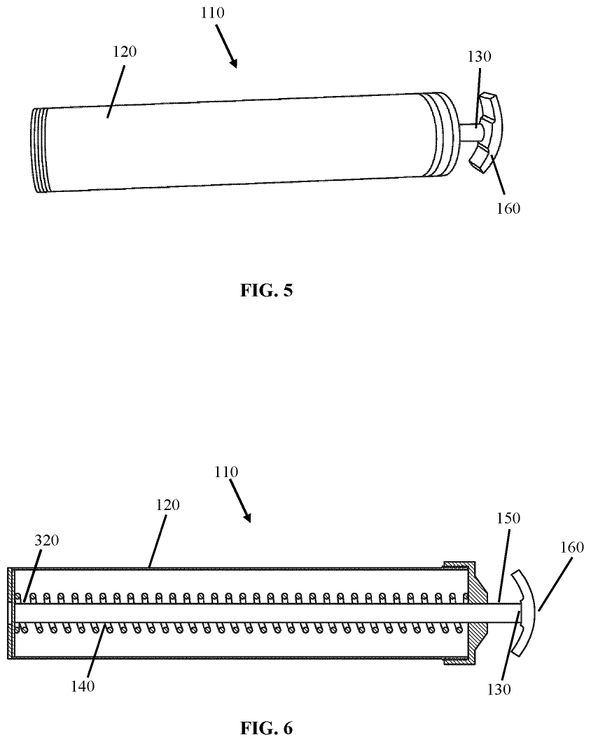

As shown in FIGS. 1-3, 5 and 6, at least one canister assembly 110 includes canister 120. Canister 120 may be cylindrical. Canister 120 may vary in length. According to an embodiment, canister 120 is between 6 and 18 inches in length. Canister 120 may vary in diameter. According to an embodiment, canister 120 has a diameter between 1.5 and 2 inches. Canister 120 may be constructed of aluminum, stainless steel, or thermoplastics. According to a preferred embodiment, canister 120 is constructed of aluminum. Canister 120 contains one or more liquids to be sprayed by way of spring-loaded spraying device 100. The one or more liquids may be any of: water, paint, an acrylic, a silicone, a polyurethane, a polyurea, a liquid spray foam, a liquid insulation, a chemical, a gel, a wax, an oil, a glue, an adhesive, a liquid gas, a detergent, an emulsion, asphalt, a synthetic rubber, a sealant, or an alcohol. According to an embodiment as shown in FIGS. 1 and 6, a first end of canister 120 includes an aperture 150 through which a rod 130 extends. Rod 130 is partially contained within canister 120. According to an embodiment, a length of rod 130 exceeds a length of canister 120. Rod 130 may vary in diameter. According to a further embodiment, a first end of rod 130, proximate aperture 150, comprises a handhold 160, as shown in FIG. 1-3, 5 and 6. Handhold 160 may consist of a knob, a T-shaped extension of rod 130, a finger loop, or a handle.

As shown in FIGS. 1 and 6, canister assembly 110 further includes at least one spring 140, wherein at least one spring 140 is coiled around rod 130. As shown in FIGS. 1 and 6, at least one spring 140 may be coiled around the full length of rod 130 contained within canister 120. According to an embodiment, at least one spring 140 is coiled around a part of the length of rod 130 contained within canister 120. A spring constant of at least one spring 140 may vary. According to an embodiment, at least one spring 140 comprises at least two springs. The at least two springs may have different spring constants. The at least two springs may also vary in diameter and in length. According to an embodiment, one or more springs of the at least two springs may be coiled, in whole or in part, around one or more other springs of the at least two springs. According to a further embodiment, the at least two springs have an identical diameter and are coiled around rod 130 in sequence without overlapping. The sequential at least two springs may serve to ensure consistent force is exerted on a liquid contained within canister 4 120. A quantity, a configuration, and a spring constant of at least one spring 140 may be determined based on an intended application of spring-loaded spraying device 100.

At least one canister assembly 110 includes a spring-locking mechanism. The spring-locking mechanism may be disposed within canister 120. According to an embodiment, the spring-locking mechanism is a snap-fit mechanism comprising a protrusion emanating from and perpendicular to rod 130 and a depression disposed at a point along the canister 120. According to an embodiment, the spring-locking mechanism is a twist-lock mechanism comprising a slot within an inside wall of canister 120 and a pin connected to rod 130 and extending into the slot.

As shown in FIGS. 1 and 6, at least one canister assembly 110 may further include a disc 320, connected to an end of rod 130 proximate a canister recipient 170. Disc 320 may be in direct contact with a liquid loaded into canister 120. A diameter of disc 320 may vary. According to an embodiment, the diameter of disc 320 is such that disc 320 fits snuggly within canister 120. Disc 320 may then exclude a liquid contained within canister 120 from a portion of canister 120 occupied by rod 130 and at least one spring 140. The liquid contained within canister 120 may occupy a space between disc 320 and an end of canister 120 proximate canister recipient 170.

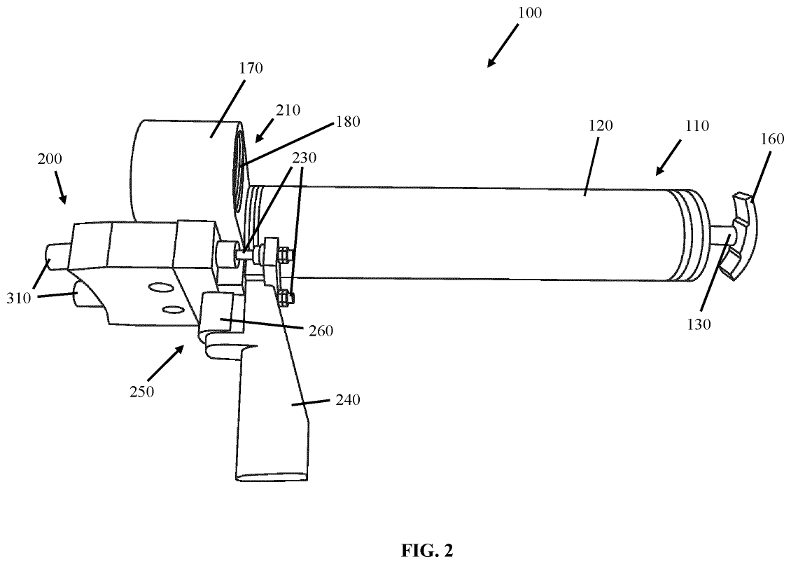

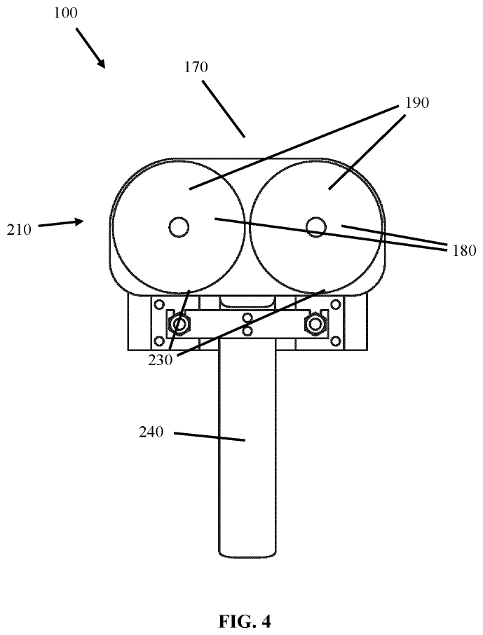

As shown in FIGS. 1-4, spring-loaded spraying device 100 further includes a canister recipient 170 for receiving at least one canister assembly 110. Canister recipient 170 may be modular, as shown in FIGS. 1-3. Canister recipient 170 may vary in shape and size. According to an embodiment, as shown in FIGS. 2 and 4, canister recipient 170 comprises at least one threaded recess 180 and an aperture in communication with at least one fluid channel 190, wherein the aperture is disposed within at least one threaded recess 180.

According to an embodiment, spring-loaded spraying device 100 includes more than one canister assembly 110 and more than one canister 120, wherein each of the more than one canister 120 contains a distinct liquid. According to another embodiment, each of the more than one canister 120 contains the same liquid. According to another embodiment, one of the more than one canister 120 contains a catalyst and another of the more than one canister 120 contains a reactant.

Spring-loaded spraying device 100 includes at least one fluid channel 190, as shown in FIGS. 1 and 4. At least one fluid channel 190 is in communication with canister 120 and extends through canister recipient 170. At least one fluid channel 190 may extend from a dispensing end 200 of canister recipient 170 to a canister receiving end 210 of canister recipient 170. At least one fluid channel 190 may vary in length, shape and diameter.

As shown in FIG. 1, at least one fluid channel 190 includes within it a valve 220. According to an embodiment, as shown in FIG. 1, valve 220 comprises a pintle 230, wherein pintle 230, in an extended configuration, obstructs a segment of at least one fluid channel 190.

According to an alternative embodiment (not shown), the spring-loaded spraying device includes one canister assembly, one threaded recess, and one fluid channel.

Spring-loaded spraying device 100 also includes a handle 240 connected to canister recipient 170, as shown in FIGS. 1-4. Handle 240 may be ergonomic. According to an embodiment, handle 240 is wholly or partly covered by a gripping material. The gripping material may be one or more of a polyvinyl chloride coating, an acrylic gripping tape, or a number of other gripping materials which would be well known to the person skilled in the art. Handle 240 may have a hollow construction. According to an embodiment, handle 240 may be solid. According to an embodiment, handle 240 may be detachably connected to canister recipient 170. Handle 240 may, alternatively, be permanently connected to canister recipient 170.

As shown in FIGS. 1 and 2, spring-loaded spraying device 100 further includes a trigger assembly 250 functionally connect with valve 220. According to an embodiment, as shown in FIG. 1, trigger assembly 250 comprises a trigger 260, a rear end of which, in a compressed configuration, extends out of a rear face of handle 240, and a plate disposed behind the rear face of handle 240 and connected to the rear end of trigger 260 and to pintle 230.

According to an embodiment, trigger assembly 250 further comprises: a hollow spring keeper (not shown) connected to a rear face of canister recipient 170, through which pintle 230 extends; an abutment (not shown) at a point along a length of pintle 230; and a pintle spring (not shown) coiled around pintle 230 between the abutment and an end of pintle 230 furthest from at least one fluid channel 190.

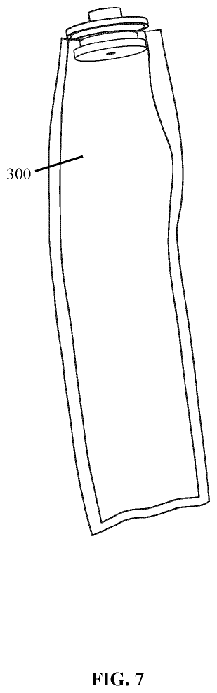

According to an embodiment, at least one canister assembly 110 further includes a flexible tube 300, as shown in FIG. 7, disposed within canister 120 between a first end of rod 130 and canister recipient 170. According to an embodiment, flexible tube 300 comprises a threaded cap, wherein the threaded cap comprises an opening in communication with a space within flexible tube 300. Flexible tube 300 may be disposable or may be reusable. Flexible tube 300 may be constructed from one or more of polyethylene and silicone. According to an embodiment, the size, shape and capacity of flexible tube 300 may vary.

According to a further embodiment, as shown in FIGS. 1-3, spring-loaded spraying device includes a nozzle 310 disposed at an end of at least one fluid channel 190 furthest from canister 120. Nozzle 310 may vary in diameter, length and shape. Nozzle 310 may be adjustable. According to an embodiment, nozzle 310 is replaceable. According to an embodiment, nozzle 310 is a flat fan nozzle, a hollow cone nozzle, a full cone nozzle, a misting nozzle, or a solid stream nozzle. The shape/configuration of the nozzle will be determined by the nature of the liquid and the nature of a spraying project for which spring-loaded spraying device is used. According to an embodiment, nozzle 310 may include one or more elbows or extensions.

Spring-loaded spraying device 100 may be constructed from materials which provide sufficient mechanical strength and durability to perform reliably over time. According to an embodiment, spring-loaded spraying device 100 may be constructed of aluminum, stainless steel, thermoplastics, or a combination of suitable materials. Manufacturing costs, weight, lifespan and mechanical strength may be considerations informing the choice of materials, construction technique and design choices of spring-loaded spraying device 100.

According to an embodiment, there is provided a method of spraying a liquid, comprising: retracting a road within a canister; locking the rod in a retracted position; loading the liquid into the canister; and unlocking the rod.

According to another embodiment, the method of spraying a liquid further comprises connecting the canister to a canister recipient; and compressing a trigger on the canister recipient. The step of connecting the canister to the canister recipient may comprise screwing a threaded end of the canister into a threaded end of the canister recipient.

Retracting the rod within the canister may compress at least one spring coiled around the rod and abutting an end of the canister proximate a user. Locking the rod in a retracted position may enable the safe loading of the liquid in a space created by the retraction of the rod. Releasing the rod may transfer the force exerted by the spring to the liquid which may enter a first end of a fluid channel in the canister recipient. The fluid channel may comprise a valve which in a closed state may prevent the liquid from exiting the canister recipient via a second end of the fluid channel. Compressing the trigger on the canister recipient may open the valve and the force exerted by the spring may push the liquid out of the canister, through the fluid channel and out of the canister recipient. The liquid may exist the fluid channel and canister recipient through a nozzle. Releasing the trigger may close the valve and prevent further liquid from being sprayed.

Compressing the trigger may open the valve by pulling back a pintle which, when the trigger is not compressed, obstructs the valve.

According to an embodiment, the step of locking the rod in a retracted position comprises rotating the rod within the canister. Rotating the rod within the canister may engage a twist lock mechanism to lock the rod in the retracted position.

According to an embodiment, the step of loading the liquid into the canister comprises loading the liquid into a flexible tube open at one end; and inserting the flexible tube into the canister. The flexible tube contains the liquid and prevents the liquid from making direct contact with the canister. In doing so, the canister is kept clean and may be subsequently used with a different liquid without the need to first clean the canister. Being flexible, the flexible tube enables the dispersion of substantially all of the liquid therein.

According to an embodiment, the step of connecting the canister to the canister recipient comprises screwing an external screw thread disposed along a first end of the canister into an internal screw thread disposed within a recess in the canister recipient. Alternatively, the step of connecting the canister to the canister recipient may comprise snapping a protruding edge on a first end of the canister into a snap-in area on the canister recipient. The step of connecting the canister to the canister recipient may alternatively comprise snapping a protruding edge on the canister recipient into a snap-in area on a first end of the canister.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. A spring-loaded spraying device, comprising:
at least one canister assembly, wherein each canister assembly comprises
a canister;
a rod partially contained within the canister;
at least one spring, wherein the at least one spring is coiled around the rod; and
a spring-locking mechanism;
a canister recipient, for receiving the at least one canister assembly;
at least one fluid channel in communication with the at least one canister and extending through the canister recipient;
a valve within the at least one fluid channel;
a trigger assembly functionally connected with the valve; and
a handle connected to the canister recipient.

2. The device of claim 1, wherein a first end of the at least one canister comprises an aperture through which the rod extends.

3. The device of claim 1, wherein the at least one spring is at least two springs.

4. The device of claim 1, wherein the canister recipient is modular.

5. The device of claim 1, wherein the at least one fluid channel extends from a dispensing end of the canister recipient to a canister receiving end of the canister recipient.

6. The device of claim 2, wherein, in an extended configuration, the rod spans the full length of the at least one canister.

7. The device of claim 1, wherein the canister assembly further comprises a flexible tube disposed within the at least one canister between a first end of the rod and the canister recipient.

8. The device of claim 7, wherein the flexible tube comprises a threaded cap, and wherein the threaded cap comprises an opening in communication with a space within the flexible tube.

9. The device of claim 1, wherein the valve comprises a pintle, wherein the pintle, in an extended configuration, obstructs a segment of the at least one fluid channel.

10. The device of claim 1, wherein the trigger assembly comprises:
a trigger, a rear end of which, in a compressed configuration, extends out of a rear face of the handle; and
a plate disposed behind the rear face of the handle and connected to the rear end of the trigger and to the pintle.

11. The device of claim 10, wherein the trigger assembly further comprises:
a hollow spring keeper connected to a rear face of the canister recipient, through which the pintle extends;
an abutment at a point along a length of the pintle; and
a pintle spring coiled around the pintle between the abutment an end of the pintle furthest from the at least one fluid channel.

12. The device of claim 2, wherein a first end of the rod comprises a handhold.

13. The device of claim 1, further comprising a nozzle disposed at an end of the at least one fluid channel furthest from the at least one canister.

14. The device of claim 1, wherein the canister recipient comprises:
at least one threaded recess; and
an aperture in communication with the at least one fluid channel, wherein the aperture is disposed within the at least one threaded recess.

15. A method of spraying a liquid, comprising:
retracting a rod within a canister;
locking the rod in a retracted position;
loading the liquid into the canister; and
unlocking the rod.

16. The method of claim 15, wherein the step of locking the rod in a retracted position comprises rotating the rod within the canister.

17. The method of claim 15, further comprising:
connecting the canister to a canister recipient; and
compressing a trigger.

18. The method of claim 15, wherein the step of loading the liquid into the canister comprises:
loading the liquid into a flexible tube; and
inserting the flexible tube into the canister.

19. The method of claim 17, wherein the step of connecting the canister to the canister recipient comprises screwing a threaded end of the canister into a threaded end of the canister recipient.
